(19) United States
(12) Patent Application Publication
(10) Pub. No.: US 2020/0012360 A1
(43) Pub. Date: Jan. 9, 2020

(54) POINTING DEVICE AND MANUFACTURING METHOD THEREOF

(71) Applicant: Microsoft Technology Licensing, LLC, Redmond, WA (US)

(72) Inventors: Hao ZHUANG, Beijing (CN); Wensheng YAO, Beijing (CN); Bin ZHAI, Beijing (CN); Junhong SUN, Beijing (CN)

(21) Appl. No.: 16/489,271

(22) PCT Filed: Mar. 3, 2017
(86) PCT No.: PCT/CN2017/075582

§ 371 Date: Aug. 27, 2019

(51) Int. Cl. G06F 3/0354; G06F 3/0362

(52) U.S. Cl. CPC G06F 3/03549; G06F 3/0362; G06F 3/03543

(57) ABSTRACT

A pointing device is provided. In one implementation, the pointing device includes a body, a control member received in a recess of the body and rotatable with respect to the body, a first rotation tracking sensor arranged in the recess and configured to track a rotation of the control member about a first axis and a second axis perpendicular to the first axis in a Cartesian coordinate system that is defined with respect to the recess, and a second rotation tracking sensor arranged in the recess and configured to track a rotation of the control member about a third axis perpendicular to the first and second axes in the Cartesian coordinate system. An associated method of manufacturing the pointing device is also provided.

### BACKGROUND

A pointing device is an input interface device that allows a user to input spatial (i.e., continuous and multi-dimensional) data to a computing device such as a personal computer. For example, CAD systems and graphical user interfaces (GUI) allow the user to control and provide data to the computer using physical gestures by moving a hand-held mouse or similar device across the surface of the physical desktop and activating switches on the mouse. Movements of the pointing device are corresponded on the screen by movements of a pointer (or so-called cursor) and other visual changes. Common gestures are point and click and drag and drop.

Conventionally, a tracking device only enables cursor navigation when a user is moving the device on a surface external to the tracking device itself (such as a table surface). When the user intends to rotate a target object in an application, he or she needs to move the cursor onto a particular virtual object, click a button on the tracking device and hold the button. The target object is then rotated as the tracking device moves in relation to the table surface in case that the button is kept being pressed (namely, a dragging operation). This operation is functional but neither intuitive nor convenient, because the movement of the tracking device with respect to the table surface is tracked in two dimensions only, while the rotation is in three dimensions in reality.

### SUMMARY

In accordance with implementations of the subject matter described herein, a pointing device is provided. Generally speaking, there is provided a handy and easy-to-use tracking device in order to improve the user experience particularly for an interface involving a rotation of a virtual object.

The pointing device includes a body, a control member, a first rotation tracking sensor, and a second rotation tracking sensor. The control member is received in a recess of the body and rotatable with respect to the body. The first rotation tracking sensor is arranged in the recess and configured to track a rotation of the control member about a first axis and a second axis perpendicular to the first axis in a Cartesian coordinate system that is defined with respect to the recess. The second rotation tracking sensor is arranged in the recess and configured to track a rotation of the control member about a third axis perpendicular to the first and second axes in the Cartesian coordinate system.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 illustrates a schematic diagram of a pointing device according to one embodiment of the subject matter described herein;

FIG. 2 illustrates a perspective view of a mouse as an example of the pointing device according to one embodiment of the subject matter described herein;

FIG. 3 illustrates a sectional view of a control member together with two tracking sensors of the mouse of FIG. 2;

FIG. 4 illustrates a bottom view of the mouse of FIG. 2;

FIG. 5 illustrates a flowchart of a method of manufacturing the pointing device in accordance with embodiments of the subject matter described herein.

### DETAILED DESCRIPTION

The subject matter described herein will now be discussed with reference to several example embodiments. These embodiments are discussed only for the purpose of enabling those skilled persons in the art to better understand the subject matter described herein, rather than suggesting any limitations on the scope of the subject matter.

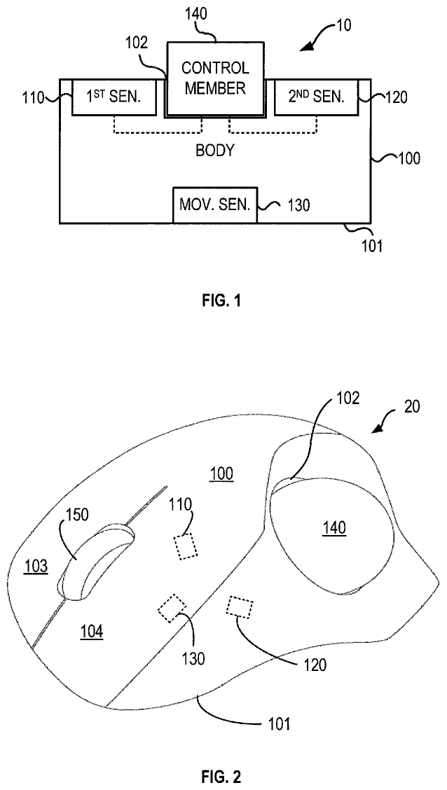

The term “includes” and its variants are to be read as open terms that mean “includes, but is not limited to.” The term “or” is to be read as “and/or” unless the context clearly indicates otherwise. The term “based on” is to be read as “based at least in part on.” The term “one embodiment” and “an embodiment” are to be read as “at least one embodiment.” The term “another embodiment” is to be read as “at least one other embodiment.” Unless specified or limited otherwise, the terms “mounted,” “connected,” “supported,” and “coupled” and variations thereof are used broadly and encompass direct and indirect mountings, connections, supports, and couplings. Further, “connected” and “coupled” are not restricted to physical or mechanical connections or couplings. In the description below, like reference numerals and labels are used to describe the same, similar or corresponding parts in the several views of FIGS. 1-5. Other definitions, explicit and implicit, may be included below.

A pointing device is commonly available in the form of a mouse, which is widely used with a computer so it is referred to as a mouse as well in some occasions. With various types of the pointing device, a user is able to navigate a cursor within a displayed area shown on a screen, so that he or she can click on a link or a virtual button at a particular position on the screen. For example, a traditional mouse incorporates a ball in a cavity for tracking the movement of the mouse in relation to a surface on which the mouse is to be held and moved by the user. As a result of a two-dimensional (2D) movement on that surface, the cursor is moved either in horizontal direction or in vertical direction on the screen correspondingly. In various embodiments as described herein, “navigation” refers to an action which controls the mouse in a manual way and accordingly moves the cursor to an intended position.

More recently, optical mice with lighting devices are more and more popular for their ease of use and navigating precision. To track the movement of an optical mouse, a surface is usually required to be put as close as possible to a window of the mouse. Such a window allows the emissions from the light source, such as a laser diode or a LED diode, to hit on the surface. Then, the emissions will be reflected (diffused) by the surface, and eventually captured by a sensor arranged in the mouse in order to detect a relative movement between the mouse and the surface. With the detected relative movement, the navigation of the optical mouse can be achieved.

A mouse having an optical sensor at its bottom side usually allows a 2D navigation. If the user wishes to rotate a particular object in a three-dimensional (3D) space rendered in a graphical interface, he or she normally clicks on the object and moves the mouse without lifting his or her finger pressing on the button of the mouse. Although the object can be rotated in this way, such an operation is not intuitive, and the rotation is limited to only two axes due to the movement of the mouse in relation to the surface corresponding to a 2D manipulation. Embodiments described herein intend to facilitate the rotation of a particular object in a 3D space in three axes, while keeping the 2D navigation of the cursor as well.

FIG. 1 illustrates a schematic diagram of a pointing device 100 according to one embodiment of the subject matter described herein. The pointing device 100 is described with only for the purpose of illustration without suggesting any limitations as to the scope of the subject matter described herein. Embodiments with different structures can realize the purpose and concept of the subject matter described herein.

As shown, the pointing device 10 includes a body 100 having a bottom side 101. The bottom side 101 can contact or become close to a surface external to the body 100 (a typical external surface can be a table surface for example) on which the pointing device 10 is placed. For example, in case that the pointing device 10 is a mouse, its bottom side 101 is substantially flat, allowing it to be placed on the external surface directly and moved by a user who holds the body 100 by his or her hand.

A movement tracking sensor 130 is arranged at the bottom side 101 of the body 100. The movement tracking sensor 130 can be an optical sensor or a mechanical sensor. Various types of sensors can be adopted, as long as it is able to convert a 2D movement of the pointing device 10 with respect to the external surface into a signal indicating the 2D movement so that the movement is tracked. In some other examples, the movement tracking sensor 130 can include two one-dimensional (1D) sensors positioned on the bottom side 101 with a 90-degrees difference between each other. In this manner, the movement of the pointing device 10 in two axes defined by the external surface can be tracked as well.

The movement tracking sensor 130 is usually used to associate the movement of the pointing device 10 with a movement of a cursor on the screen. Therefore, an object or a link or a virtual button selectable by the cursor can be accessed by the user. There are also physical buttons provided on the pointing device 10, in particular on the body 100, for the user to point on. Such an action may have the object or link or virtual button selected when the cursor is positioned on it. Although these operations are generally intuitive to the user of the pointing device, they are configurable and can be redefined by the user when desired.

In one example embodiment of the present disclosure, a first rotation tracking sensor 110 and a second rotation tracking sensor 120 are provided in a recess 102 of the body 100. The recess 102 can be positioned on a surface opposite to the bottom side 101, or can be positioned elsewhere other than the bottom side 101. A control member 140 is detachably received in the recess 102 and rotatable with respect to the body 100. Usually, the control member 140 can be in a form of a sphere, so that is can be freely rotated in relation to other parts of the pointing device 10. However, other shapes such as a polygon or acanthosphere can be used as well, so long as it is rotatable about three axes in a Cartesian coordinate system within the recess 102. The arrangement of the control member 140 is advantageous because the user can freely rotate the control member 140, which enables many navigation or control commands to be configured in various applications. For example, a rotation of a virtual object in a hologram space, or a navigation in a video game. In the meantime, the navigation or control functions brought by the movement tracking sensor 130 remains.

It is to be understood that, although the movement tracking sensor 130 is shown in various embodiments of the present disclosure and it is demonstrated to be beneficial in combination with the use of the first rotation tracking sensor 110 and the second rotation tracking sensor 120, such a movement tracking sensor 130 is not necessary. In other words, the existence of the first rotation tracking sensor 110 and the second rotation tracking sensor 120 is already sufficient to bring about the advantageous technical effects of the present disclosure, as discussed in the context.

The rotation of the control member 140 is detected by either the first rotation tracking sensor 110 or the second rotation tracking sensor 120 in the recess 102. In one example, each of the second and second rotation tracking sensors 110, 120 is able to track the rotation of the control member 140 about two axes in Cartesian coordinates. In other words, each of the second and second rotation tracking sensors 110, 120 is a 2D motion detector which associates the rotation of the control member 140 in one or two axes in the Cartesian coordinate system with respect to itself. The use of two 2D tracking sensors is beneficial, because two sensors track movement on a total of four axes. When only three axes in a Cartesian coordinate system are in interest, the capability of tracking four axes allows additional precision.

The rotation of the control member 140 can be fully represented in a Cartesian coordinate system with 3 axes normally denoted by X, Y and Z. A 2D tracking sensor only detects a rotation about two axes. For example, in a typical Cartesian coordinate system which includes three axes X, Y, Z perpendicular with each other, if one 2D tracking sensor is arranged on purpose to detect a rotation about X and Y axes, it fails to detect a rotation purely about Z axis. By using two 2D tracking sensors and placing them differently with an angle between each other with respect to a center of the control member 140, the rotation of the control member 140 can be reflected in all the three axes in the coordinates. As a result, a 3D rotation of the control member 140 with respect to the body 100 can be tracked by the two tracking sensors 110, 120.

In one example, each of the second and second rotation tracking sensors 110, 120 can be an optical sensor or a mechanical sensor. Various types of sensors can be adopted, as long as it is able to convert a rotation of the control member 140 with respect to the recess 102 in two axes into a signal indicating the rotation in two axes so that the rotation is tracked. In FIG. 1, the second and second rotation tracking sensors 110, 120 are connected to the control member 140 via dot lines, which indicate the signals optical or mechanical couplings between the sensors and the control member 140.

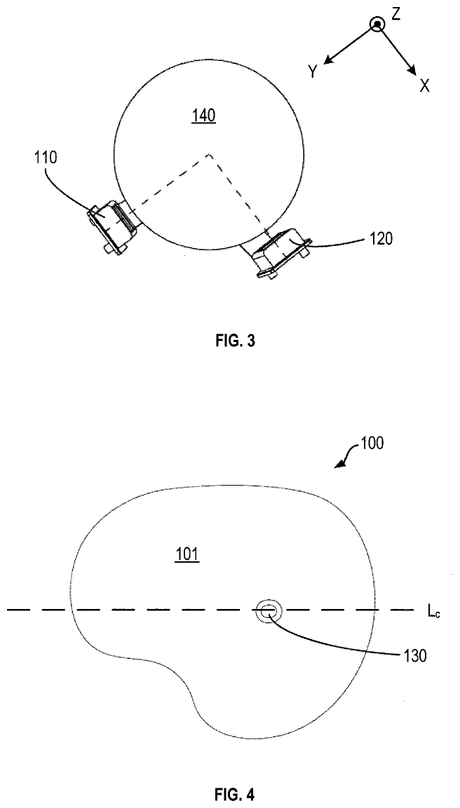

FIG. 2 illustrates a perspective view of a mouse 20 as an example of the pointing device 10 according to one embodiment of the subject matter described herein. FIG. 3 illustrates a sectional view of a control member 140 together with two tracking sensors 110, 120 of the mouse 20. FIG. 4 illustrates a bottom view of the mouse 20.

As shown in FIG. 2, a mouse 20 has a body 100 shaped to be placed on an external surface (like a table surface) by its bottom side 101, and be held by a hand of a user on a surface opposite to the bottom side 101. The surface opposite to the bottom side 101, which can be referred to as an “upper” surface in this example, can be shaped to be ergonomic so as to ameliorate fatigue in use. First, second and second rotation tracking sensors 130, 110, 120 are provided in the body 100 which functions similarly to those explained with regard to FIG. 1. The three sensors are denoted in three doted boxes in FIG. 2 to indicate their coarse positions.

It is to be understood that “top”, “upper”, “bottom”, “front”, “rear”, “side”, “lateral” and the like are only used to describe the relationship between the components in the figures, instead of limiting their orientation or positioning. For example, although the “bottom” side 101 is oriented downwardly as shown in FIG. 2, it can be oriented toward other direction and this depends on how the device is to be used.

Specifically, as described above, the movement tracking sensor 130 is located at the bottom side 101 which is used to track the 2D movement of the body 100 with respect to the external surface (like a table surface). This can be shown in FIG. 4, in which the bottom side 101 is substantially flat. FIG. 4 also shows a longitudinal centerline Lₑ, along which the body 100 is split into two parts laterally. In this example, the second and second rotation tracking sensors 110, 120 are located in the recess 102 so that they can be optically coupled with a control member 140 placed in the recess 102.

In this example, the control member 140 is in a form of a sphere or a ball. The recess 102 and the control member 140 are positioned close to a thumb of a user's hand holding the body 100 on the external surface. Namely, the center of the control member 140 is arranged away from the longitudinal centerline Lₑ of the body 100 shown in FIG. 4. This is an ergonomic and intuitive design which allows the user easily accessing the control member 140 with his or her thumb. Although FIG. 2 shows a mouse 20 designed for a right-handed user, other shapes of the mouse can be designed accordingly for left-handed users as well.

In one example, two buttons 103 and 104 can be additionally provided on the upper surface designed to be clicked on, so that a target object can be selected for example. A scroll tracking sensor (not shown) and a wheel 150 can be provided on the upper surface. In this example, the scroll tracking sensor is able to track a 1D rotation of the wheel 150 with respect to the body 100. This normally allows for a scrolling action of a shown page on the screen or a zoom-in/zoom-out action of a target object selected previously by pressing the buttons 103 and 104.

In FIG. 3, the control member 140, the second and second rotation tracking sensors 110, 120 are shown in a sectional view. The control member 140 is shown as a perfect ball in this example in which a distance between any point on the surface of the ball and a center of the ball is fixed in principle, although other shapes can be used for the control member 140 as well. A Cartesian coordinate system is also shown for illustrating X, Y and Z axes, in which any one of the axes is always perpendicular to the other two axes. The second and second rotation tracking sensors 110, 120 are positioned close to the control member 140 with a certain distance so that the rotation of the control member 140 is detectable by the two sensors.

The first rotation tracking sensor 110 is positioned away from the center of the control member 140 along the Y axis, while the second rotation tracking sensor 120 is positioned away from the center of the control member 140 along the X axis. In other words, the first rotation tracking sensor 110 is positioned away from the second rotation tracking sensor by 90 degrees with respect to the center of the control member 140. In this way, the first rotation tracking sensor 110 is able to detect a rotation of the control member 140 about either X axis or Z axis, while the second rotation tracking sensor 120 is able to detect a rotation of the control member 140 about either Y axis or Z axis. As a result, by using the two tracking sensors positioned differently, the rotation of the control member 140 about any of the three axes is detectable.

It is to be understood that the two tracking sensors are not necessarily angled by 90 degrees with respect to the center. For example, the second rotation tracking sensor 120 can be angled by any value between 1 to 179 degrees as long as the rotation of the control member 140 about Y axis is detectable.

In this way, the rotation of the control member 140 about either axis will be detectable, and thus the user can control a target object displayed on a screen, which may be a 3D rendered object in CAD software. In addition, a target object in a hologram space is also controllable by rotating the control member 140. For example, the target object can be rotated by an angle equal to the 3D rotation of the control member 140. In other words, if the user rotates the control member 140 by 20 degrees purely about Y axis, the target object in a virtual 3D space shown on the screen is also rotated by 20 degrees about Y axis. Alternatively, such a mapping may not necessarily 1:1, meaning that the target object can be rotated by an angle proportional to the 3D rotation of the control member 140. In other words, the angle that the control member 140 has been rotated by may result a smaller or larger angle rotated on the screen, and this can pre-set by the user in software at any time.

It is to be understood that in addition to the rotation control, the control member 140 can be used to carry out other operations as well. The control member 140 permits utilizing three degrees of freedom (DOF) in almost any user interface or human-machine interface. By incorporating two DOF enabled by the movement tracking sensor 130 and additionally one DOF enabled by the wheel 150, a total of six DOF is typically provided, all of which can be defined by the user in software when needed for a particular application.

The apparatus in accordance with the embodiments of the subject matter described herein provides a handy tracking device which is intuitive for navigation and object rotation. The rotation of a target object is allowed in all three dimensions, while the navigation (of a cursor) is still possible in the course of the rotation, and vice versa. This thus allows an improved user experience for a user interface that is otherwise impossible by existing tracking devices on the market.

The above examples are described only for the purpose of illustration, without suggesting any limitations as to the scope of the subject matter described herein. Any additional or alternative materials can be used to make the components of the switch.

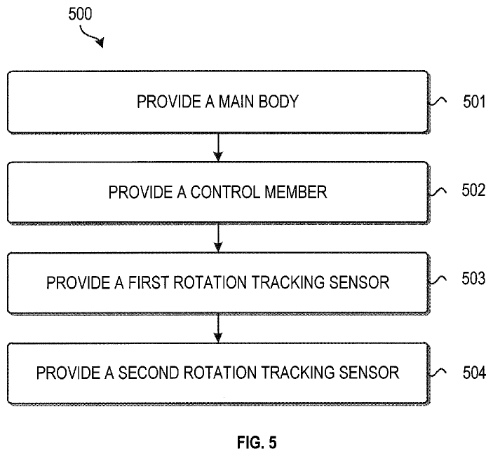

With reference to FIG. 5, it illustrates a block diagram of a method 500 of manufacturing the tracking device in accordance with embodiments of the subject matter described herein.

The method 500 is entered at block 501, where a body is provided.

At block 502, a control member received in a recess of the body and rotatable with respect to the body is provided.

At block 503, a first rotation tracking sensor arranged in the recess and configured to track a rotation of the control member about a first axis and a second axis perpendicular to the first axis in a Cartesian coordinate system that is defined with respect to the recess is provided.

At block 504, a second rotation tracking sensor arranged in the recess and configured to track a rotation of the control member about a third axis perpendicular to the first and second axes in the Cartesian coordinate system. The control member can be then installed into the recess when the pointing device is to be used.

The pointing device has already been described above by reference to FIGS. 1 to 4, and thus detailed explanations to its configuration, structure or function are not to be repeated, because the pointing device can be constructed exactly the same as the pointing device 10 or mouse 20 described above.

While operations are depicted in a particular order in the above descriptions, this should not be understood as requiring that such operations be performed in the particular order shown or in sequential order, or that all illustrated operations be performed, to achieve desirable results. In certain circumstances, multitasking and parallel processing may be advantageous. Likewise, while several details are contained in the above discussions, these should not be construed as limitations on the scope of the subject matter described herein, but rather as descriptions of features that may be specific to particular embodiments. Certain features that are described in the context of separate embodiments may also be implemented in combination in a single embodiment. On the other hand, various features that are described in the context of a single embodiment may also be implemented in multiple embodiments separately or in any suitable sub-combination.

### Example Implementations

Hereinafter, some example implementations of the subject matter described herein will be listed.

In some implementations, there is provided a pointing device. The pointing device comprises: a body; a control member received in a recess of the body and rotatable with respect to the body; a first rotation tracking sensor arranged in the recess and configured to track a rotation of the control member about a first axis and a second axis perpendicular to the first axis in a Cartesian coordinate system that is defined with respect to the recess; and a second rotation tracking sensor arranged in the recess and configured to track a rotation of the control member about a third axis perpendicular to the first and second axes in the Cartesian coordinate system.

In some implementations, further comprising a movement tracking sensor arranged at a bottom side of the body and configured to track a two-dimensional movement of the bottom side with respect to a surface external to the body.

In some implementations, the control member is in a form of a sphere.

In some implementations, the first rotation tracking sensor is arranged away from the second rotation tracking sensor by 90 degrees with respect to a center of the control member.

In some implementations, the second and second rotation tracking sensors are configured to track a 2D rotation of the control member with respect to the recess.

In some implementations, a center of the control member is arranged away from a longitudinal centerline of the body.

In some implementations, the movement tracking sensor is an optical sensor.

In some implementations, the second and second rotation tracking sensors are optical sensors.

In some implementations, there is provided a method of manufacturing a pointing device. The method comprises: providing a body; providing a control member received in a recess of the body and rotatable with respect to the body; providing a first rotation tracking sensor arranged in the recess and configured to track a rotation of the control member about a first axis and a second axis perpendicular to the first axis in a Cartesian coordinate system that is defined with respect to the recess; and providing a second rotation tracking sensor arranged in the recess and configured to track a rotation of the control member about a third axis perpendicular to the first and second axes in the Cartesian coordinate system.

In some implementations, further comprising providing a movement tracking sensor arranged at a bottom side of the body and configured to track a two-dimensional movement of the bottom side with respect to a surface external to the body;

In some implementations, providing the control member includes providing the control member in a form of a sphere.

In some implementations, providing the first rotation tracking sensor arranged away from the second rotation tracking sensor by 90 degrees with respect to a center of the control member.

In some implementations, the second and second rotation tracking sensors are configured to track a 2D rotation of the control member with respect to the recess.

In some implementations, providing a center of the control member arranged away from a longitudinal centerline of the body.

In some implementations, providing a wheel; and providing a scroll tracking sensor configured to track a one-dimensional rotation of the wheel with respect to the body.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A pointing device comprising:
a body;
a control member received in a recess of the body and rotatable with respect to the body;
a first rotation tracking sensor arranged in the recess and
configured
to track a rotation of the control member about a first axis and a
second axis perpendicular to the first axis in a Cartesian
coordinate system that is defined with
respect to the recess; and
a second rotation tracking sensor arranged in the recess and configured to track a rotation of the control member about a third axis
perpendicular to the first and second axes in the Cartesian coordinate system.

2. The pointing device according to claim 1,
further comprising:
a movement tracking sensor arranged at a bottom side of
the body
and configured to track a two-dimensional (2D) movement of the bottom side with respect to a surface external to the body.

3. The pointing device according to claim 1, wherein the control member is in a form of a sphere.

4. The pointing device according to claim 3,
wherein the first rotation tracking
sensor is arranged away from the second rotation tracking sensor by 90 degrees with respect to a center of the control member.

5. The pointing device according to claim 1,
wherein the second and second
rotation tracking sensors are configured to track a 2D rotation of the control member with respect to the recess.

6. The pointing device according to claim 1, wherein a center of the control member is arranged away from a longitudinal centerline of the body.

7. The pointing device according to claim 2, wherein the movement tracking sensor is an optical sensor.

8. The pointing device according to claim 1, wherein the second and second rotation tracking sensors are optical sensors.

9. The pointing device according to claim 1,
further comprising:
a wheel; and
a scroll tracking sensor configured to track a one-dimensional (1D) rotation of the wheel with respect to the body.

10. The pointing device according to claim 1, wherein the pointing device is a mouse.

11. A method of manufacturing a
pointing device, comprising: providing a body;
providing a control member received in a recess of the body and
rotatable with
respect to the body;
providing a first rotation tracking sensor arranged in the recess and
configured to
track a rotation of the control member about a first axis and a second axis perpendicular to the first axis in a Cartesian coordinate system that is defined with
respect to the recess; and
providing a second rotation tracking sensor arranged in the recess and
configured
to track a rotation of the control member about a third axis perpendicular to the first
and second axes in the Cartesian coordinate system.

12. The method according to claim 11, further comprising:
providing a movement tracking sensor arranged at a bottom side of the body and configured to track a two-dimensional (2D) movement of the bottom side with respect to a
surface external to the body.

13. The method according to claim 11, wherein providing the control member includes providing the control member in a form of a sphere.

14. The method according to claim 13, further comprising:
providing the first rotation tracking sensor arranged away from the second rotation tracking sensor by 90 degrees with respect to a center of the control member.

15. The method according to claim 11, wherein the second and second rotation tracking sensors are configured to track a 2D rotation of the control member with respect to the recess.

16. The method according to claim 11, further comprising:
providing a center of the control member arranged away from a longitudinal centerline of the body.

17. The method according to
claim 11, further comprising: providing a wheel; and
providing a scroll tracking sensor configured to track a one-dimensional
rotation of the wheel with respect to the body.
